(19) United States
(12) Patent Application Publication
(10) Pub. No.: US 2006/0139618 A1
(43) Pub. Date: Jun. 29, 2006

(54) Power tool with electronic distance measurement

(76) Inventor: Richard Pando, Corona, CA (US)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/026,948

(22) Filed: Dec. 29, 2004

(51) Int. Cl. G01C 3/08; B26D 7/27

(52) U.S. Cl. 356/4.01; 356/5.01; 83/522.19

(57) ABSTRACT

A power tool has an electronic distance measuring system that includes a wave source that transmits a wave to an object, and a receiver that receives a reflected wave from the object. A microprocessor is used to calculate a distance based on the transmitted wave and the reflected wave, and display information relating to the distance using an indicator. A reflector can be temporarily attached to a workpiece as needed.

### FIELD OF THE INVENTION

The field of the invention is power tools.

### BACKGROUND OF THE INVENTION

Traditionally, saws and other power tools are used in conjunction with a ruler or tape measure when a measured cut is needed. The process of cutting a piece of wood, for example, usually involves marking the wood where it is to be cut, aligning the wood with the cutting blade, and finally cutting the wood—a three step process.

One early improvement was to align the workpiece using calibrations notched into or printed on the power tool itself. That improvement can completely eliminate marking of the workpiece, and is in use even today.

A persisting problem with calibrated tools, however, it that the calibration can become difficult to read over time. This can be due to wear, dust, inadequate lighting, and possibly other reasons as well. Another problem with having the calibration on the tool itself is that it typically extends the size of the tool. For example, if a calibration of 5 feet is needed, there must be some component of the tool that extends 5 feet. That is simply not practical in many circumstances, especially for exceedingly long distances.

Thus, there is a need for power tools with alternative means of measuring.

### SUMMARY OF THE INVENTION

The present invention provides a power tool comprising a wave source, a wave receiver, and a microprocessor that are used to provide distance information. The distance information is used in many ways, but typically is used in a process involving the power tool. For instance, a wave can be reflected off a mirror or other object at the end of a piece of wood or metal, for the purpose of measuring the distance to a saw blade. The object that reflects the waves can be either coupled to the power tool or uncoupled (i.e. standalone).

In another aspect, the inventive subject matter includes a power tool with a distance measuring mechanism comprising a wheel. The wheel is rolled along a length of a surface in order to calculate a distance that is relevant to use of the tool.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a perspective view of inventive portions of a miter saw.

FIG. 2 is a side view of an alternative power saw.

FIG. 3 is a perspective view of inventive portions of a radial arm saw.

FIG. 4 is a schematic of a control unit.

FIG. 5 is a perspective view of inventive portions of a miter saw having a rolling distance measurement.

### DETAILED DESCRIPTION

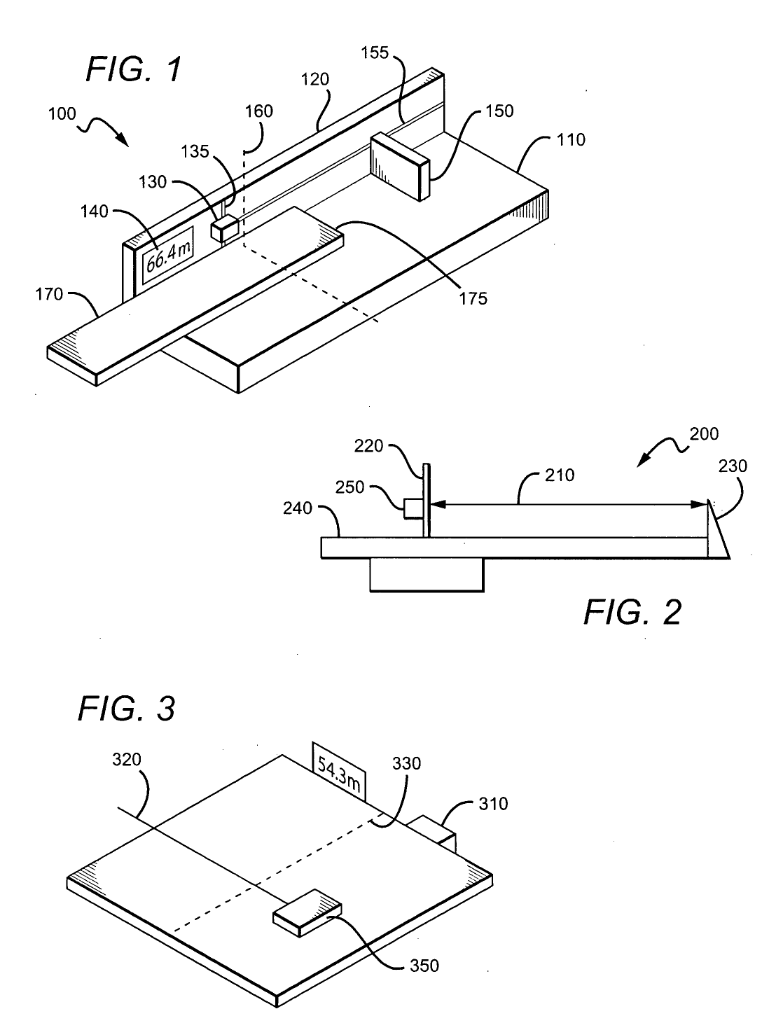

Referring first to FIG. 1, a miter saw 100 has a cutting surface 110, a fence 120, a control unit 130, a digital display 140, and an object 150. Control unit 130 includes a wave source, a wave receiver, and a microprocessor. While a miter saw is shown here, the inventive concepts are applicable to substantially any power tool, including other types of saws, hand drills, drill presses, routers, lathes, and so on.

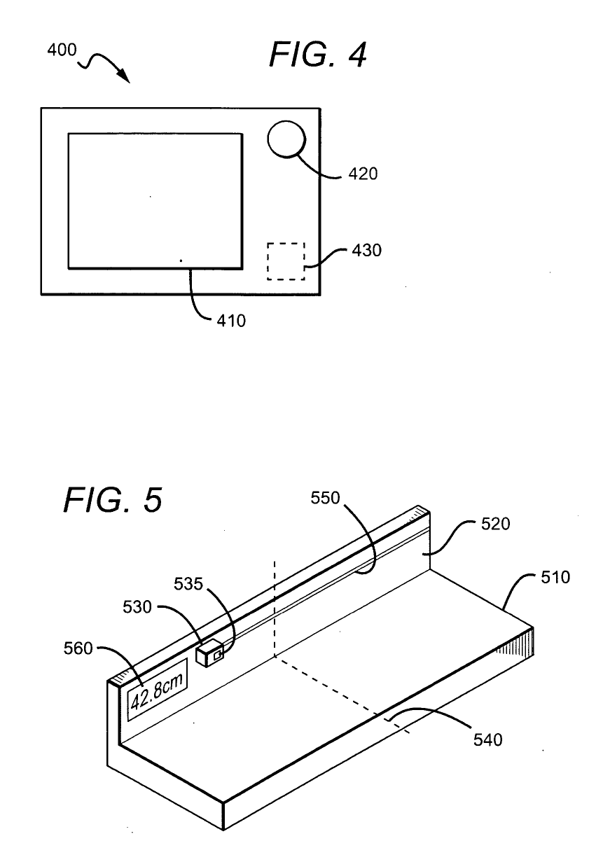

Control unit 130 is mounted to the tool in a location where it can transmit and receive waves with relatively little interference from other parts of the tool or from the item being worked on. Of course, depending on the wave type, interference may have little effect on the transmission and receipt of waves by the control unit. In the figure, control unit 130 is mounted along vertical channel 135 so as to enable height adjustments to the unit. While it is preferable that the control unit be positioned so that it calculates the distance from the plane of the blade to the object, it is not necessary that the control unit be positioned adjacent to the plane of the blade as the control unit should be capable of adjusting for its distance from the plane of the blade. In fact, the control unit can be completely separate from the tool so long as it can take its distance from the plane of the blade into consideration. Additional detail about the components and the functionality of the control unit will be discussed with reference to FIG. 4.

Object 150 reflects waves back to the wave receiver housed in control unit 130. In the embodiment depicted, object 150 is mounted to the fence of the saw and moves horizontally back and forth along channel 155. By sliding the object along channel 155, the object 150 can be moved into a position that is substantially adjacent to the end of the wood 175. Once the object is in place, the control unit can make its measurement from the blade plane to the object. This measurement represents the length of the wood after the cut is made.

The term “wave” as used herein generally includes waves of varying wavelengths, amplitudes, velocity, and frequency. Any appropriate electromagnetic or non-electromagnetic wave will suffice including most especially sound waves, optical waves, radio waves, visible light waves, and infrared waves so long as the wave can be transmitted, reflected by the object, and thereafter received. The term “reflected” means that the wave changes direction and comes back toward the wave source. Those skilled in the art will appreciate that the constituent material and reflective properties of object 150 can vary depending on the type of wave being emitted by the control unit. It should also be appreciated that the reflective properties will differ depending on the type and wavelength of wave being used. When using sound waves the reflective properties of the object can not matter as much as when using light waves.

In operation, the wave source transmits a wave to an object, the wave bounces off the object, and the wave is received by the wave receiver. Using known methods, a micro-processor calculates the distance from the wave source to the object. Information about the distance is then communicated to and displayed on the display unit 140. Such information preferably includes the distance from point a (i.e. the saw blade) to point b (i.e. the object). In some embodiments, the distance can be used to make another calculation. For instance, the distance from a drill chuck to the wall can be used to calculate the depth that the drill bit enters the wall. Thus, the information that display unit 140 displays may not be the actual distance between the wave source and the object, but rather another distance calculated by using that distance.

In an alternative class of embodiments, the indicator of the distance is not a digital display, but rather an audible (e.g. verbal) indication or alarm. In fact, an audible indication can be safer than a visual indication because the user of the machine does not have to look away from it in order to know that the work piece, blade, or tool is properly positioned. In still other embodiments the indicator can be a light that turns on or off, or changes color when a given distance is measured.

Referring now to FIG. 2, a power saw 200 is shown from a side view. In this view the distance 210 between the saw blade 220 and the object 230 can be easily observed. It can also be observed that object 230 abuts the end of the wood 240. It should be recognized that placement of the object can vary so long as the control unit is capable of adjusting for such placement. Object 230 is shaped so that it can stand up and be in range of the waves being transmitted from the control unit 250. In other embodiments, the object can be something as simple as a piece of thin (5 mm or less) reflective material that is stuck to the end of the item being cut. Thus, there is no requirement that the object be of any particular size or shape or that it even be coupled to the tool only that it be within range of the waves and capable of reflecting them back.

In FIG. 3, relevant portions of a radial arm saw are depicted. Functionally, the radial arm saw is a little different from a miter saw or chop saw because the blade is not stationary. Here, not only does object 350 reflect waves back to control unit 310, but it also casts a laser line 320 that intersects the path of the blade indicated by line 330. This laser line enables the user of the radial arm saw to determine exactly how far to pull the blade.

FIG. 4 shows detail of the components of the control unit 400—the wave receiver 410, wave source 420, and microprocessor 430. It should be understood that because angles of incidence and angles of reflection can vary, the size and location of the wave receiver may need to vary as well. In some embodiments, the wave receiver may need to be housed separately from the wave source. Similarly, the microprocessor can be housed in a device other than the control unit.

Microprocessor 430 receives digital signals from the signal receiver and uses those signals along with the communication from the wave source to calculate the distance between the wave source and the object. In addition, the microprocessor can be further programmed to make additional calculations. In the case of a drill, the microprocessor can be programmed to figure out how far the drill bit has entered the object being drilled. This is a simple algorithm that involves calculating the difference between a starting distance and a current distance. Say, the starting distance was 6 cm and the current distance is 3.5 cm, then we know that approximately a 2.5 cm hole has been made.

Wave source 420 is contemplated to be any device capable or producing a wave that is appropriate for this invention including coherent light sources (e.g. a laser) non-coherent light sources (e.g. a light emitting diode), and sound producing sources (e.g. an eccentrically mounted disc). Additionally, wave sources that produced pulse waves are also contemplated.

FIG. 5 shows portions of a miter saw including a cutting base 510, a fence 520, and a distance measuring mechanism 530.

Distance measuring mechanism 530 comprises a wheel (not shown) that is geared to a counter in order to calculate distance. The function of a measuring wheel is well known, but they generally work by incrementing a counter for each full revolution of the wheel. The number of revolutions is then multiplied by the circumference of the wheel in order to calculate the distance. Distance measuring mechanism 530 is electromechanical and it includes a start/stop button 535 that initiates and terminates measurement of a distance. In other less preferred embodiments, the function of the distance measuring mechanism may be entirely mechanical.

In operation, the user of the distance measuring mechanism 530 begins the distance measurement at a point on the tool (the plane of the saw blade identified by dotted line 540) by actuating the start/stop button 535. As the mechanism 540 is moved horizontally along channel 550, distance information is displayed by the indicator 560. When the desired distance has been reached, the user again actuates the start/stop button. It is contemplated that actuation of the start/stop button can cause the distance measuring mechanism to cast a laser line down the fence and across the cutting base so that an item being cut can be marked or moved into alignment with the laser line.

Thus, specific embodiments and applications of a power tool with electronic distance measurement have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A power tool, comprising:
a wave source that transmits a wave to an object;
a receiver that receives a reflected wave from the object;
a microprocessor that calculates a distance based on the transmitted wave and the reflected wave; and
an indicator that provides information about the distance.

2. The construction tool of claim 1, wherein the wave source transmits optical waves.

3. The construction tool of claim 2, wherein the optical waves are coherent.

4. The construction tool of claim 1, wherein the wave source transmits sound waves.

5. The construction tool of claim 4, wherein the sound waves are pulsed.

6. The construction tool of claim 1, wherein the object is a user placed reflector.

7. The construction tool of claim 1, wherein the object is a fence coupled to the tool.

8. The construction tool of claim 1, wherein the object is separate from the tool.

9. The construction tool of claim 1, further comprising a saw blade.

10. The construction tool of claim 1, further comprising a drill bit.

11. The construction tool of claim 1, wherein the distance represents a length of a piece of wood.

12. The construction tool of claim 1, wherein the distance represents a depth of a hole.

13. The construction tool of claim 1, wherein the indicator comprises a digital display.

14. The construction tool of claim 1, wherein the indicator comprises an audible signal.

15. A power tool, comprising:
a rolling distance measurement mechanism coupled to the tool and adapted to measure a distance beginning at a point on the tool; and
an indicator that provides information about the distance.
